(19) United States
(12) Patent Application Publication
(10) Pub. No.: US 2002/0107986 A1
(43) Pub. Date: Aug. 8, 2002

(54) Methods and systems for replacing data transmission request expressions

(76) Inventors: Thomas Pfohe, Hamburg (DE); Thorsten Laux, Hamburg (DE)

Correspondence Address: SONNENSCHEIN NATH & ROSENTHAL, P.O. BOX 061080, WACKER DRIVE STATION, CHICAGO, IL, 60606-1080, US

(21) Appl. No.: 10/037,399

(22) Filed: Dec. 21, 2001

(30) Foreign Application Priority Data
Dec. 22, 2000 (EP) 00128213.6

(51) Int. Cl. G06F 15/16

(52) U.S. Cl. 709/246; 709/239

(57) ABSTRACT

Methods, systems, and articles of manufacture consistent with the present invention replace data transmission request expressions (such as URLs). A data transmission request expression of a first type is received from a recipient. The data transmission request expression corresponds to data identified by a data transmission request expression of a second type to be transmitted to the recipient. The data transmission request expression of the first type is replaced with a replacement data transmission request expression of the second type. The data is retrieved using the replacement data transmission request expression. The data is then sent to the recipient.

### CROSS-REFERENCE TO RELATED APPLICATIONS

This Application claims priority to the filing date of the following foreign patent application, which is incorporated herein by reference:

European Patent Application No. 00128213.6, entitled “METHOD AND APPARATUS FOR REPLACING DATA TRANSMISSION REQUEST EXPRESSIONS”, filed on Dec. 22, 2000.

### FIELD OF THE INVENTION

The present invention relates to client/server data processing environments, and in particular, the invention relates to processing data transmission request expressions in a client/server data processing environment.

### BACKGROUND OF THE INVENTION

In a client/server data processing environment, a client may send to a server a request for data transmission, where the data represents, for example, the content of a web page to be displayed at the client to a user through the use of a browser. When requesting such data from the server, the client has to uniquely identify the requested data by sending to the server a unique data transmission request expression (DTRE), such as a uniform resource locator (URL), allowing the server to access and retrieve the required data and to transmit it to the client. Uniform resource locators are used in applications relating to the Internet for accessing data sources forming part of the World Wide Web.

Some clients are capable of handling and processing one type (e.g., a first type) of unique expressions, which can be handled and processed by the server as well. A server, however, is usually capable of handling and processing that one type of unique expressions as well as additional types of unique expressions. These additional unique expressions may be considered as a second type of unique expressions.

For example, in a client/server data processing environment, a client may be capable of handling and processing URLs of a single given length (e.g., 128 characters long), whereas a server may handle and process URLs of any length (e.g., 256, 1024, 2048 or more characters). The server is limited to handling and processing URLs of certain lengths due to the way operations are implemented on the server in software processes and by the physical structure of the server hardware, e.g., by its random access memory (RAM). URLs having a maximum length of N characters (for example: N =128) may be considered as short URLs and URLs having a practically unlimited length may be considered as long URLs.

Based on the above-described problems of client/server environments, it is therefore desirable to improve them.

### SUMMARY OF THE INVENTION

Methods, systems, and articles of manufacture consistent with the present invention provide a client with the ability to retrieve data from a server, although the client would not typically be able to do so because the client does not support an expression type required to request the data. This ability is provided by the server replacing the client's request expression with a replacement expression that corresponds to the data. For example, a client that supports short URLs but not long URLs is able to retrieve web pages that are identified by long URLs. In this example, the server replaces the client's request expression (e.g., a short URL) with a replacement expression (e.g., a long URL) that corresponds to the data. The server determines the replacement expression from a lookup table that lists client request expressions (e.g., short URLs) and their corresponding replacement expressions (long URLs). Accordingly, the client is permitted access to any data, including data that is identified by expressions (e.g., URLs) that the client is not typically able to support.

In accordance with methods consistent with the present invention, a method in a data processing system for replacing data transmission request expressions is provided. The method comprises the steps of: receiving a data transmission request expression of a first type from a requester, the data transmission request expression corresponding to data identified by a data transmission request expression of a second type; replacing the data transmission request expression of the first type with a replacement data transmission request expression of the second type; retrieving the data using the replacement data transmission request expression; and sending the retrieved data to the requestor.

In accordance with methods consistent with the present invention, a method in a data processing system for replacing data transmission request expressions is provided. The method comprises the steps of: retrieving data with a data transmission request expression of a first type for sending to a requestor; replacing the data transmission request expression in the retrieved data with a replacement data transmission request expression of a second type; and sending the retrieved data with the replacement data transmission request expression to the requester.

In accordance with methods consistent with the present invention, a method in a data processing system having a web server with a web page is provided. The method comprises the steps performed by the web server of: receiving a first URL of a first type from a client, the first URL corresponding to the web page identified by a URL of a second type; replacing the first URL with a replacement URL of the second type; retrieving the web page using the replacement URL; and sending the retrieved web page to the client.

In accordance with articles of manufacture consistent with the present invention, a computer-readable medium containing instructions that cause a data processing system to perform a method for replacing data transmission request expressions is provided. The method comprises the steps of: receiving a data transmission request expression of a first type from a requester, the data transmission request expression corresponding to data identified by a data transmission request expression of a second type; replacing the data transmission request expression of the first type with a replacement data transmission request expression of the second type; retrieving the data using the replacement data transmission request expression; and sending the retrieved data to the requester.

In accordance with articles of manufacture consistent with the present invention, a computer-readable medium containing instructions that cause a data processing system to perform a method for replacing data transmission request expressions is provided. The method comprising the steps of: retrieving data with a data transmission request expression of a first type for sending to a requestor; replacing the data transmission request expression in the retrieved data with a replacement data transmission request expression of a second type; and sending the retrieved data with the replacement data transmission request expression to the requestor.

In accordance with articles of manufacture consistent with the present invention, a computer-readable medium containing instructions that cause a data processing system having a web server with a web page to perform a method for replacing URLs is provided. The method comprises the steps of: receiving a first URL of a first type from a client, the first URL corresponding to the web page identified by a URL of a second type; replacing the first URL with a replacement URL of the second type; retrieving the web page using the replacement URL; and sending the retrieved web page to the client.

In accordance with systems consistent with the present invention, a data processing system is provided. The data processing system comprises: a secondary storage device having a stored data identified by a data transmission request expression of a first type; a memory comprising a computer program that receives a data transmission request expression of a second type from a requester, the data transmission request expression corresponding to data, replaces the data transmission request expression of the second type with a replacement data transmission request expression of the first type, retrieves the data using the replacement data transmission request expression, and sends the retrieved data to the requester; and a processing unit that runs the computer program.

In accordance with systems consistent with the present invention, a data processing system is provided. The data processing system comprises: a secondary storage device having a stored data having a data transmission request expression of a first type; a memory comprising a computer program that retrieves the data for sending to a requester, replaces the data transmission request expression in the retrieved data with a replacement data transmission request expression of a second type, and sends the retrieved data with the replacement data transmission request expression to the requestor; and a processing unit that runs the computer program.

In accordance with systems consistent with the present invention, a data processing system for replacing data transmission request expressions is provided. The data processing system comprises: means for receiving a data transmission request expression of a first type from a requester, the data transmission request expression corresponding to data identified by a data transmission request expression of a second type; means for replacing the data transmission request expression of the first type with a replacement data transmission request expression of the second type; means for retrieving the data using the replacement data transmission request expression; and means for sending the retrieved data to the requestor.

In accordance with systems consistent with the present invention, a data processing system for replacing data transmission request expressions is provided. The data processing system comprises: means for retrieving data with a data transmission request expression of a first type for sending to a requestor; means for replacing the data transmission request expression in the retrieved data with a replacement data transmission request expression of a second type; and means for sending the retrieved data with the replacement data transmission request expression to the requestor.

In accordance with articles of manufacture consistent with the present invention, a computer-readable memory device encoded with a data structure and a program that accesses the data structure is provided. The program is run by a processor in a system. The data structure has a plurality of entries, each entry comprising: a data transmission request expression of a first type for retrieving a document identified by a data transmission request expression of a second type, wherein the program replaces the data transmission request expression of the first type with a data transmission request expression of a second type before retrieving the document.

The above-mentioned and other features, utilities, and advantages of the invention will become apparent from the following detailed description of the preferred embodiments of the invention together with the accompanying drawings.

Other systems, methods, features, and advantages of the invention will become apparent to one with skill in the art upon examination of the following figures and detailed description. It is intended that all such additional systems, methods, features, and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 depicts a block diagram of a client/server based data processing system with which embodiments of the present invention may be implemented;

FIG. 2 depicts a block diagram of a data structure with which embodiments of the present invention may be implemented;

FIG. 3 depicts a flow diagram illustrating the steps for replacing data transmission request expressions, in accordance with methods, systems, and articles of manufacture consistent with the present invention;

FIG. 4 depicts a flow diagram illustrating the steps of an embodiment for replacing data transmission request expressions in retrieved data, in accordance with methods, systems, and articles of manufacture consistent with the present invention;

FIG. 5 depicts a flow diagram illustrating the steps of another embodiment for replacing data transmission request expressions in retrieved data, in accordance with methods, systems, and articles of manufacture consistent with the present invention;

FIG. 6 depicts a flow diagram illustrating the steps for replacing data transmission request expressions with a generated replacement data transmission request expression, in accordance with methods, systems, and articles of manufacture consistent with the present invention;

FIG. 7 depicts a flow diagram illustrating the steps for using a hash function to read a replacement data transmission request expression, in accordance with methods, systems, and articles of manufacture consistent with the present invention;

FIG. 8 depicts a block diagram of the client/server based data processing system of FIG. 1 with a replacement table in secondary storage, in accordance with methods, systems, and articles of manufacture consistent with the present invention;

FIG. 9 depicts a block diagram of the client/server based data processing system of FIG. 1 including a second server, in accordance with methods, systems, and articles of manufacture consistent with the present invention;

FIG. 10 depicts a block diagram of the client/server based data processing system of FIG. 1 having a plurality of replacement tables, in accordance with methods, systems, and articles of manufacture consistent with the present invention;

FIG. 11 depicts a block diagram of the client/server based data processing system of FIG. 1 having a plurality of replacing programs and a plurality of replacement tables, in accordance with methods, systems, and articles of manufacture consistent with the present invention; and

FIG. 12 depicts a block diagram of a replacement table, in accordance with methods, systems, and articles of manufacture consistent with the present invention.

### DETAILED DESCRIPTION OF THE INVENTION

Reference will now be made in detail to an implementation consistent with the present invention as illustrated in the accompanying drawings. Wherever possible, the same reference numbers will be used throughout the drawings and the following description to refer to the same or like parts.

In accordance with methods, systems, and articles of manufacture consistent with the present invention, a client is able to retrieve data from a server, although the client would not typically be able to do so because the client does not support an expression type required to request the data. For example, a client that supports short URLs but not long URLs is able to retrieve web pages that are identified by long URLs. This capability is provided by the server replacing the client's request expression (e.g., a short URL) with a replacement expression (e.g., a long URL) that corresponds to the data. Accordingly, the client is permitted access to any data, including data that is identified by expressions (e.g., URLs) that the client is not typically able to support.

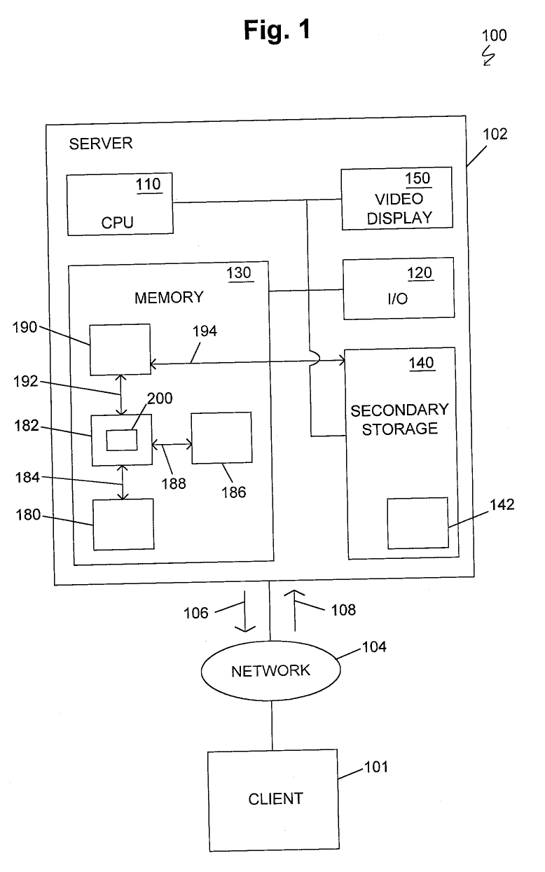

FIG. 1 depicts a block diagram of a client/server based data processing system 100 with which methods, systems, and articles of manufacture consistent with the present invention may be implemented. A client computer system 101 and a server computer system 102 are each connected to a network 104, such as a Local Area Network, Wide Area Network, or the Internet. Client computer system 101 is illustrated as communicating with server computer system 102, as indicated by arrows 106 and 108. As will be described below, server computer system 102 can communicate with client computer system 101, for example, for receiving and transmitting data. Client computer system 101 can transmit to server computer system 102 an expression requesting the transmission of data, such as content data of a web page, as illustrated by arrow 106, and server computer system 102 can transmit the requested data to client computer system 101, as illustrated by arrow 108.

Server computer system 102 comprises a central processing unit (CPU) 110, an input output I/O unit 120, a memory 130, a secondary storage device 140, and a video display 150. Server computer system 102 may further comprise standard input devices such as a keyboard, a mouse or a speech processing means (each not illustrated). Server computer system 102 may be, for example, a web server.

Memory 130 contains a communication program 180, a replacing program 184, a replacement table 186, and a retrieving program 190. Transfer of data is illustratively depicted between communication program 180 and replacing program 182 by arrow 184, between replacing program 182 and replacement table 186 by arrow 188, between replacing program 182 and retrieving program 190 by arrow 192, and between retrieving program 190 and secondary storage 140 by arrow 194. Each of these programs and replacement table 186 will be described in more detail below. These programs and replacement table 186 may comprise or may be included in one or more code sections containing instructions for performing their respective operations. While these programs and replacement table 186 are described as being implementation as software, however, the present implementation may be implemented as a combination of hardware and software or hardware alone. Also, one of skill in the art will appreciate that these programs and replacement table 186 may comprise or may be included in a data processing device, which may be a server, communicating with server computer system 102.

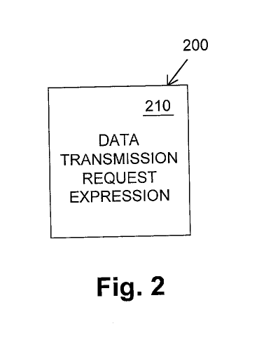

Replacing program 184 includes a data structure 200 having entries reflecting DTREs. FIG. 2 depicts a more detailed diagram of data structure 200. The sample data structure 200 that is depicted in FIG. 2 represents a DTRE. As will be described in more detail below, replacing program 184 replaces an original DTRE 210 contained in a data received from communication program 180 with a replacement expression (R-DTRE) read from replacement table program 186.

Although aspects of one implementation are depicted as being stored in memory, one skilled in the art will appreciate that all or part of systems and methods consistent with the present invention may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of client-server based data processing system 100 have been described, one skilled in the art will appreciate that a data processing system suitable for use with methods, systems, and articles of manufacture consistent with the present invention may contain additional or different components. Also, the server computer system can serve a plurality of clients communicating with the server computer system.

One of skill in the art will appreciate that client computer system 101 contains similar components as the server computer systems.

As stated above, the server computer system receives from the client computer system an expression (i.e., a DTRE) requesting the transmission of data, such as data that defines a web page. The data is stored in secondary storage 140 of the server computer system. In turn, the server computer system can transmit the requested data to the client computer system, for example for display on the client computer system. In accordance with methods, systems, and articles of manufacture consistent with the present invention, the client computer system, which is capable of handling DTREs of a first data type (e.g., short URL), can request from the server computer system the transmission of data that is identified by a DTRE of a second type (e.g., long URL), which is different than the first type.

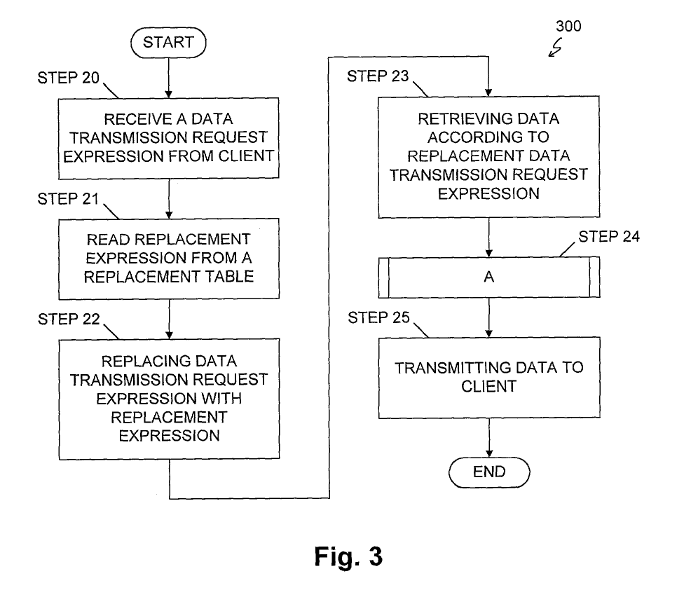

FIG. 3 depicts a flow diagram 300 illustrating exemplary steps for allowing a client computer system to request from a server computer system the transmission of data, which is identified by a DTRE of the second type. First, the communication program 180 of the server computer system receives a data transmission request expression (DTRE) from the client computer system (step 20). Communication program 180 allows the server computer system to communicate with the client computer system. Communication programs, such as communication program 180, which allow a server to communicate with a client via a network, are known in the art and will not be described in more detail. The DTRE can be a part of a larger group of data received at the server computer system from the client computer system. The DTRE uniquely identifies some data or data block, such as the content of a web page, to be transmitted from the server computer system to the client computer system based on the DTRE. The DTRE can be, for example, a URL, such as www.exampleurl.com.

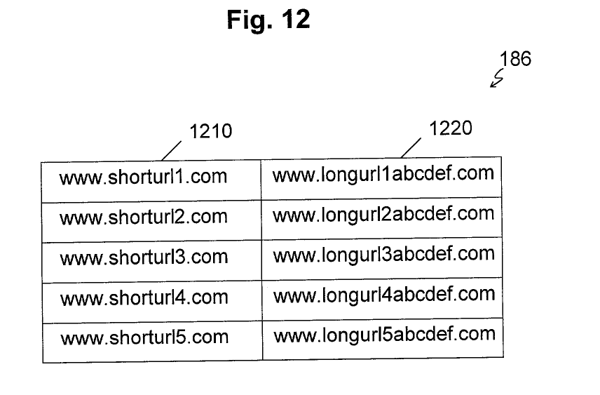

Then, communication program 180 transfers the DTRE to replacing program 182, allowing replacing program 184 to read a replacement expression corresponding to the DTRE from replacement table 186 (step 21). When replacing program 182 receives the DTRE, replacing program 182 accesses replacement table 186 to look up in replacement table 186 an entry that corresponds to the DTRE. Replacement table 186 comprises, for example, an array or other suitable memory structure for storing a plurality of data entries. The entries of the replacement table 186 are valid DTREs that uniquely identify data stored in secondary storage 140 or at some other location, for example on another server. An illustrative replacement table 186 is depicted in FIG. 12. As illustrated, a first column 1210 of the table comprises one or more entries of short URLs, and a second column 1220 of the table comprises one or more entries of corresponding long URLs. For example, replacing program 182 reads a long URL (e.g., www.longurllabcde.com) from replacement table 186 that corresponds to a short URL (e.g., www.shorturll.com) received from communication program 180.

If replacement program 182 determines that a corresponding entry exists in replacement table 186, replacing program 182 reads from replacement table 186 the replacement expression (e.g., the long URL) which corresponds to the DTRE received from communication program 180.

Then, replacing program 182 replaces the DTRE with the replacement expression (R-DTRE) read from replacement table 186 (step 22). The replacing operation performed by replacing program 182 may comprise comparing DTREs stored in replacement table unit 186, and, after having identified a corresponding DTRE entry in replacement table 186, reading the corresponding R-DTRE from replacement table 186. Alternatively, the replacing operation performed by replacing program 182 may comprise computing a key value on a basis of the DTRE and accessing the replacement table 186 using the key value for reading the corresponding R-DTRE from replacement table 186. Functions for computing a key value may be hash functions as, for example, described in Donald E. Knuth, “The Art of Computer Programming”, Vol. 3 “Sorting and Searching”, pages 506-649 (Addison Wesley Publishing Company, 1973), which is incorporated herein by reference.

Then, replacing program 182 forwards the R-DTRE to retrieving program 190, which accesses secondary storage 140 to retrieve (read) the requested data (e.g., the data content of a web page) stored in secondary storage 140 (step 23).

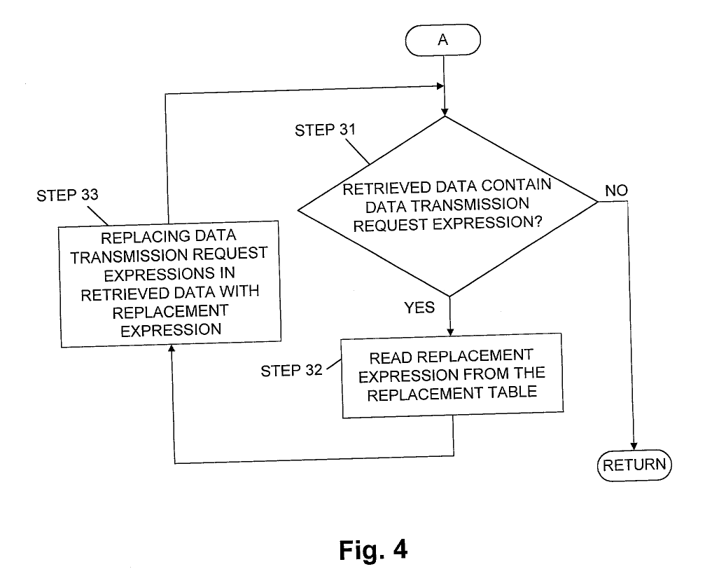

Then, retrieving program 190 forwards the retrieved data to replacing program 182, which processes any DTRE that may be contained in the retrieved data (step 24). The process of step 24 is depicted in more detail in FIG. 4. Referring to FIG. 4, first, replacing program 182 determines whether the retrieved data contains a DTRE (step 31). If replacing program 182 determines that the retrieved data contains a DTRE in step 31, then replacing program 182 reads a replacement expression corresponding to the DTRE from replacement table 186 (step 32). In other words, after replacing program 182 identifies the DTRE in the retrieved data, replacing program 182 accesses replacement table 186 to look up, in replacement table 186, an entry that corresponds to the DTRE in the retrieved data. If replacement program 182 determines that a corresponding entry exists in replacement table 186, replacing program 182 reads from replacement table 186 the replacement expression (i.e., the R-DTRE) which corresponds to the DTRE in the retrieved data.

Then, replacing program 182 replaces the DTRE in the retrieved data with the R-DTRE read from replacement table 186 (step 33). The replacement operation of step 33 is similar to the replacement operation described above with respect to step 23.

Then, the replacing program returns to step 31 to determine whether the retrieved data contains any further DTREs.

If replacing program 182 determines that there are no DTREs in the retrieved data in step 31, then, referring back to FIG. 3, replacing program 182 communicates the retrieved data to communication program 180 for transmission by communication program 180 to the client computer system (step 25).

One of skill in the art will appreciate that the steps of process 300 do not have to be performed in the illustrated order, and that one or more of the steps of process 300 can be removed. For example, step 24 of process 300 can be removed, wherein retrieving program 190 communicates the retrieved data directly to communication program 180 for transmission to the client computer system.

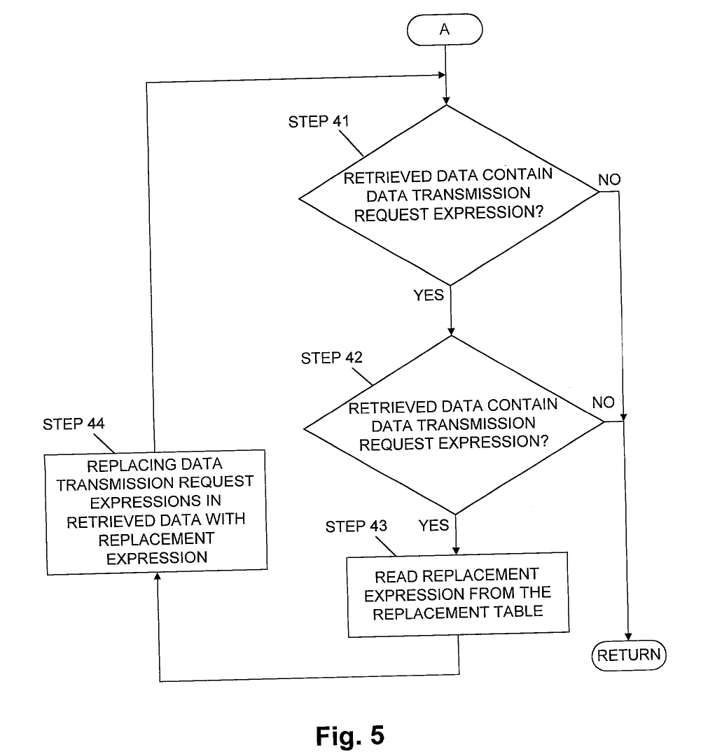

Further, in step 24 of process 300, replacing program 182 may analyze a DTRE present in the retrieved data to decide whether a replacement expression should be read from replacement table 186. This may be done because the client computer system may not be capable of handling and processing the DTRE contained in the retrieved data. For example, the retrieved data may contain a long URL, while the client computer system may not be able to handle or process long URLs. An illustrative depiction of step 24 operating as such is shown in FIG. 5. In FIG. 5, first, replacing program 182 determines whether the retrieved data contains a DTRE (step 41). If replacing program 182 determines that the retrieved data contains a DTRE in step 41, then replacing program 182 determines whether the DTRE contained in the retrieved data needs to be replaced in order for the client computer system to be capable of handling and processing the DTRE in the retrieved data (step 42). In determining whether the DTRE needs to be replaced, replacing program 182 can, for example, access a lookup table (not shown) in memory 130 to determine whether the client computer system can handle and process DTREs of that type (e.g., long URL).

If replacing program 182 determines that the DTRE in the retrieved data needs to be replaced in step 42, then replacing program 182 reads a replacement expression corresponding to the DTRE from replacement table 186 (step 43). In other words, after replacing program 182 identifies the DTRE in the retrieved data, replacing program 182 accesses replacement table 186 to look up in replacement table 186 an entry that corresponds to the DTRE in the retrieved data. If replacement program 182 determines that a corresponding entry exists in replacement table 186, replacing program 182 reads from replacement table 186 the replacement expression (i.e., the R-DTRE) which corresponds to the DTRE in the retrieved data.

Then, replacing program 182 replaces the DTRE in the retrieved data with the R-DTRE read from replacement table 186 (step 44). The replacement operation of step 33 is similar to the replacement operation described above with respect to step 23.

Then, the replacing program returns to step 41 to determine whether the retrieved data contains any further DTREs in the retrieved data.

If replacing program 182 determines that there are no DTREs in the retrieved data in step 41, or determines that a DTRE in the retrieved data does not need to be replaced in step 42, then, referring back to FIG. 3, replacing program 182 returns to step 25 to communicate the retrieved data to communication program 180 for transmission by communication program 180 to the client computer system.

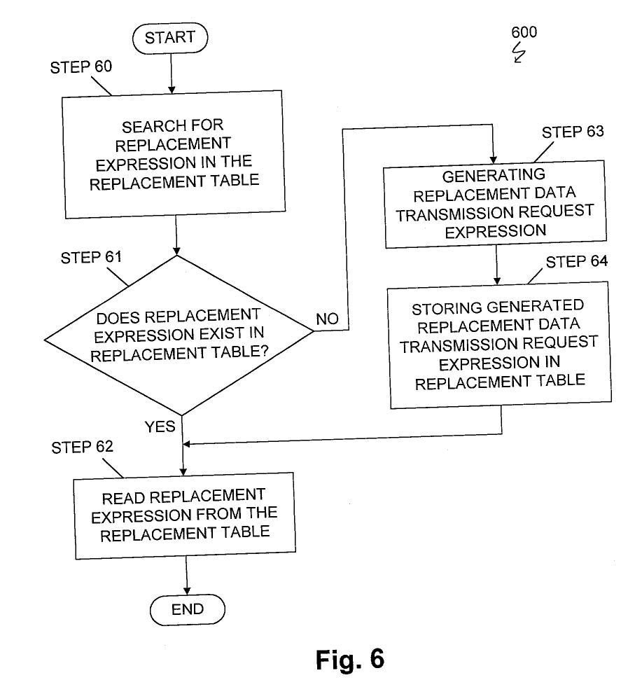

Further, if replacing program 182 determines that the DTRE received in the retrieved data is such that the client computer system is not capable of handling and processing it and if no replacement expression exists in replacement table 186 (steps 21, 32 or 43), replacing program 182 may generate a replacement DTRE that can be handled and processed by the client computer system and may store the generated replacement DTRE in replacement table 186 together with information that allows replacing program 182 to subsequently identify the newly generated replacement DTRE to correspond to other DTREs received in the retrieved data. Thus, if the client computer system returns a DTRE received from the server computer system, which expression has been replaced by replacing program 182 after replacing program 182 has generated a new replacement DTRE and after having stored it in replacement table 186, replacing program 186 may look up the corresponding new replacement DTRE in replacement table 186. This is illustratively depicted in process 600 in FIG. 6. Process 600 can replace steps 21, 32, or 43 in the above-described flow diagrams.

In FIG. 6, first, replacing program 182 searches the replacement table 186 for an R-DTRE that corresponds to the DTRE, as described above (step 60). Then, replacing program 182 determines whether such an R-DTRE exists in replacement table 186 (step 61). If replacing program 182 determines that the desired R-DTRE does not exists in replacement table 186 in step 61, then replacing program 186 generates the R-DTRE (step 63). For example, if the DTRE is a short URL and no corresponding long URL exists in replacement table 186, replacing program 186 will generate an R-DTRE of a long URL type based on the identifiers stored in, for example, a table (not shown) in memory of the retrievable data stored in secondary storage 140.

Then, replacing program 182 stores the generated R-DTRE in replacement table 186 so that the generated R-DTRE can be read from replacement table 186 (step 64).

If replacing program 182 determines that the desired R-DTRE exists in replacement table 186 in step 61 or after the newly generated R-DTRE has been stored in step 64, then, replacing program 182 reads the R-DTRE from replacement table 186 (step 62).

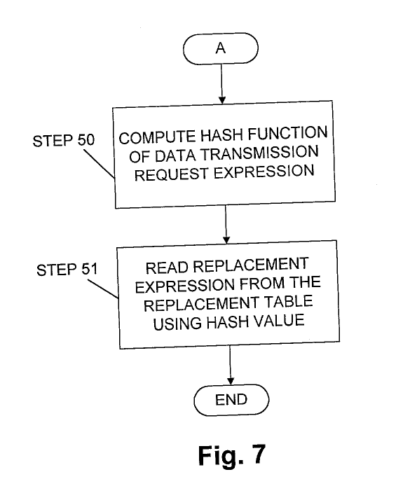

Further, in alternate embodiments consistent with the present invention, steps 21, 32, or 43 may be replaced with process 700 depicted in FIG. 7. Referring to FIG. 7, first, replacing program 182 uses a hash function and a hash table to compute a hash value on a basis of the DTRE received from the client computer system (step 50). Replacing program then uses the hash value to read a replacement expression from replacement table 186 (step 51). Using a hash function and a hash table to store and access replacement expressions provides a fast replacement operation. The principles of hash functions and hash tables are known from Donald E. Knuth, “The Art of Computer Programming”, Vol. 3 “Sorting and Searching”, pages 506-649 (Addison Wesley Publishing Company, 1973), which is incorporated herein by reference.

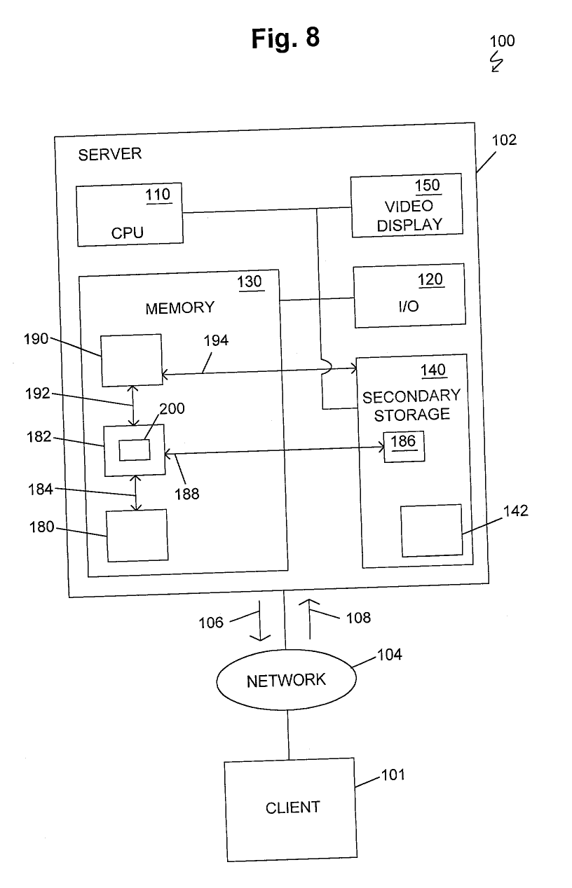

In the above description, replacement table 186 is illustratively located in memory 130. Alternatively, replacement table 186 can be located on secondary storage 140, for example as a data file, as shown in FIG. 8. Referring to FIG. 8, replacing program 182 transfers data to and receives data from replacement table 186 in secondary storage 140, as indicated by arrow 188. Accordingly, after receiving a DTRE, replacing program 182 accesses secondary storage 140, or more specifically replacement table 186, to read or write an R-DTRE corresponding to the DTRE.

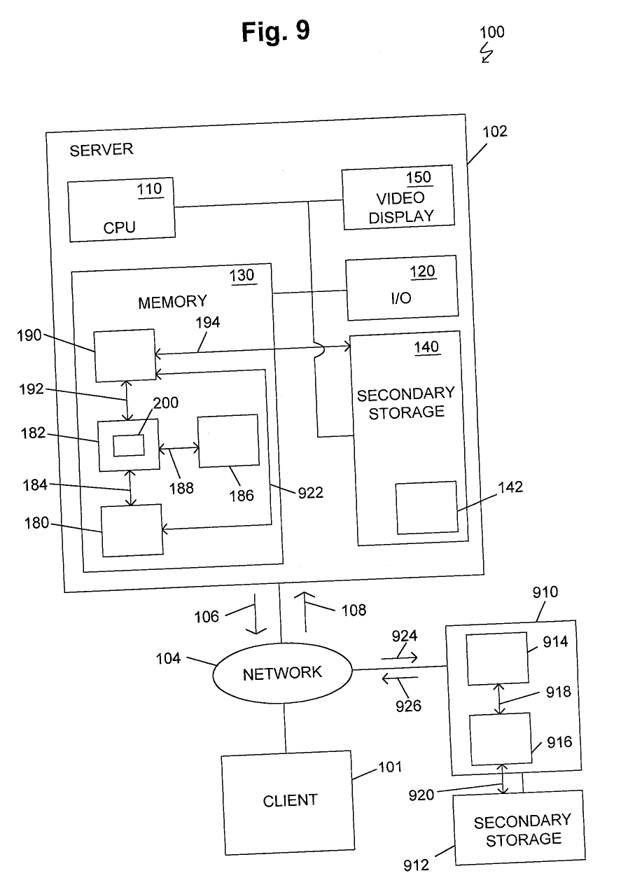

As shown in FIG. 9, retrieving program 190 can retrieve data, such as content data of a web-site, from a secondary storage 912 of a second server 910, as well as from secondary storage 140 of server computer system 102. Referring to FIG. 9, in order to retrieve data from secondary storage 912 of second server 910, retrieving program 190 communicates with communication program 180, as indicated by arrow 922. When retrieving program 190 receives an R-DTRE from replacing program 182, as described above, retrieving program 190 either accesses secondary storage 140 to retrieve (read) content data stored in secondary storage 140 or transmits the R-DTRE via communication program 180 of server computer system 102 to second server 910, as indicated by arrow 926. Second server 910 comprises a communication program 914, which is similar to communication program 180, to receive the R-DTRE transmitted from server computer system 102. Communication program 914 of second server 910 communicates with a retrieving program 916 of second server 910, as indicated by arrow 918.

When retrieving program 916 of second server 910 receives an R-DTRE, retrieving program 916 accesses secondary storage 912 of second server 910 to retrieve (read) data, for example content data of a web-site, stored in secondary storage 912. Thereafter, retrieving program 916 communicates the retrieved content data to communication program 914 of second server 910 for subsequent transmission to server computer system 102, as indicated by arrow 118. When data are transmitted from second server 910 to server computer system 102, as indicated by arrow 118, communication program 180 of server computer system 102 receives the transmitted data and forwards the data to retrieving program 190, as indicated by arrow 922. Thereafter, retrieving program 190 of server computer system 102 communicates the retrieved data to replacing program 182 for subsequent forwarding to communication program 180 for transmission to client computer system 101. Alternatively, as described above, retrieving program 190 of server computer system 102 may communicate the retrieved data directly to communication program 180 for transmission to client computer system 101.

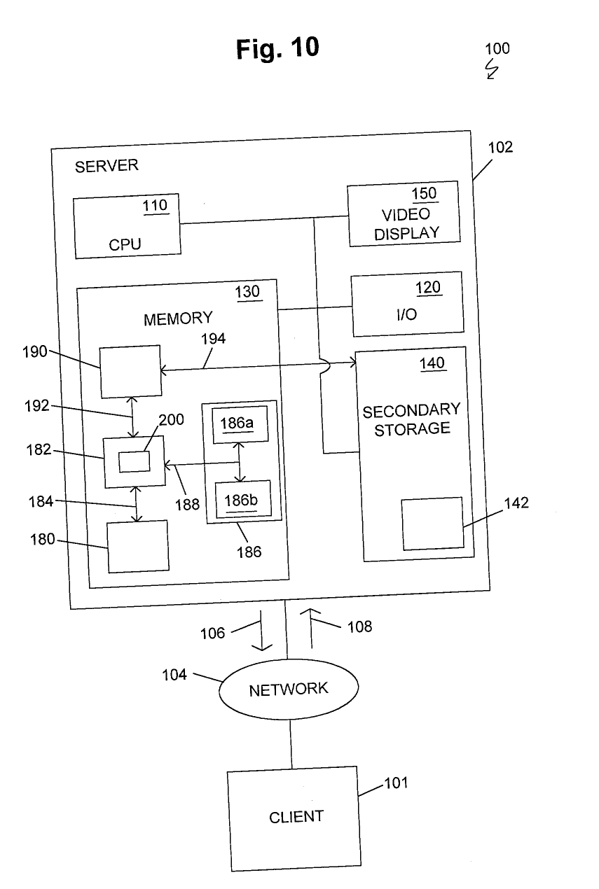

As shown in FIG. 10, replacement table 186 can comprise a plurality of replacement tables. For example, as illustratively shown in FIG. 10, replacement table 186 can comprise a first replacement table 186a and a second replacement table 186b. When receiving a DTRE from client computer system 101, replacing program 182 accesses first replacement table 186a to look up and read an entry that corresponds to the DTRE received from client computer system 101 via communication program 180. When receiving a DTRE from retrieving program 190, replacing program 182 accesses second replacement table 186b to look up and read an entry that corresponds to the DTRE received from retrieving program 190. In the embodiment shown in FIG. 10, since two separate replacement tables 186a and 186b are provided for replacing program 182 to look up and read an entry that corresponds to a DTRE received from either client computer system 101 or from receiving program 190, replacement tables 186a and 186b may be optimized for the operation of looking up and reading the respective replacement DTREs.

For example, first and second replacement tables 186a and 186b may comprise a hash table allowing replacing program 182 access to entries on a basis of a hash function and a hash table, which is computed for the DTRE received either from client computer system 101 or retrieving program 190. The use of hash functions herein is described above. First and second replacement tables 186a and 186b allow replacing program 182 faster access to the entries, especially when using a hash table and a hash function for accessing the entries.

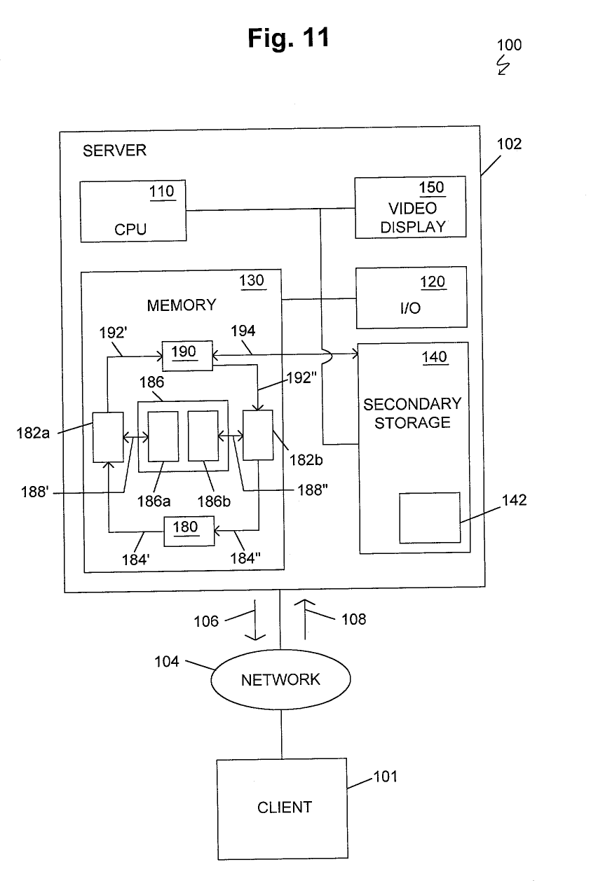

As shown in FIG. 11, replacing program 182 can comprise a plurality of replacing programs, such as a first replacing program 182a and a second replacing program 182b, and replacement table 186 can comprise a plurality of replacement tables, such as first replacement table 186a and second replacement table 186b. As illustrated, communication program 180 communicates with first replacing program 182a, as illustrated by arrow 184′, allowing first replacing program 182a to replace DTREs that may be included in data received from client computer system 101. When receiving a DTRE from client computer system 101 via communication program 180, first replacing program 182a accesses first replacement table 186a, as indicated by arrow 188′, to look up an entry that corresponds to the DTRE received from client computer system 101 via communication program 180. If a corresponding entry exists in replacement table 186a, first replacing program 182a reads from first replacement table 186a the replacement expression that corresponds to the DTRE. First replacing program 182a replaces the DTRE contained in the data received from client computer system 101 via communication program 180 with the R-DTRE read from first replacement table 186a. Then, first replacing program 182a forwards the data received from communication program 180, however, now containing the R-DTRE, to retrieving program 190 as indicated by arrow 192′.

When retrieving program 190 receives an R-DTRE, retrieving program 190 accesses secondary storage 140 to retrieve (read) data stored in secondary storage 140, as described above. Thereafter, retrieving program 190 communicates the retrieved data to second replacing program 182b, as indicated by arrow 192″, allowing second replacement program 182b to replace DTREs that may be included in the data transmitted from retrieving program 190 to second replacing program 182b.

If the retrieved data contains a DTRE, second replacing program 182b may access a second replacement table 186b, as indicated by arrow 188″, to look up in second replacement table 186b whether a replacement expression exists for the DTRE. If replacing program 182b determines that a replacement expression exists in second replacement table 186b, then second replacing program 182b reads the replacement expression from second replacement table 186b and replaces, in the data received from retrieving program 190, the DTRE with the R-DTRE. Thereafter, second replacing program 182b communicates the data, now including the R-DTRE, to communication program 180, as indicated by arrow 1184″, for transmitting the requested content data, however, now containing one or more R-DTREs, to client computer system 101.

Although first and second replacement tables 186a and 186b are shown in FIG. 11, one of skill in the art will appreciate that a single replacement table 186 may be provided, which is accessed by the first and second replacing programs 182a and 182b. Still further, one of skill in the art will appreciate that replacement table 186 depicted in FIG. 11 may be located in secondary storage 140, as discussed above.

As mentioned above, a DTRE may be a uniform resource location (URL). If a short URL is used, i.e., a URL of a first maximum length, for example 128 characters, the replacement expression may be a long URL, i.e., a URL of a second maximum length, for example more than 128 characters, in a case where the client transmits a short URL to the server and the short URL is replaced with a long URL. Similarly, a long URL received from retrieving program 190, either separately or contained in data retrieved from secondary storage 140, may be replaced with a short URL for transmission to the client.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software but the present implementation may be implemented as a combination of hardware and software or hardware alone. The invention may be implemented with both object-oriented and non-object-oriented programming systems. The scope of the invention is defined by the claims and their equivalents.

What is claimed is:

1. A method in a data processing system for replacing data transmission request expressions, the method comprising the steps of:
receiving a data transmission request expression of a first type from a requestor, the data transmission request expression corresponding to data identified by a data transmission request expression of a second type;
replacing the data transmission request expression of the first type with a replacement data transmission request expression of the second type;
retrieving the data using the replacement data transmission request expression; and
sending the retrieved data to the requester.

2. The method of claim 1, further comprising the steps of:
determining whether the retrieved data comprises a data transmission request expression of the second type; and
when the retrieved data comprises a data transmission request expression of the second type, replacing the data transmission request expression in the retrieved data with a replacement data transmission request expression of the first type.

3. The method of claim 1, further comprising the steps of:
determining whether the retrieved data comprises an embedded data transmission request expression;
when the retrieved data comprises the embedded data transmission request expression, determining whether the data transmission request expression is supported by the requestor; and
when data transmission request expression in the retrieved data is not supported by the requestor, replacing the data transmission request expression in the retrieved data with a replacement data transmission request expression supported by the requestor.

4. The method of claim 1, further comprising the step of:
identifying the replacement data transmission request expression as an entry in a lookup table corresponding to the data transmission request expression of the first type.

5. The method of claim 1, further comprising the steps of:
computing a hash value based on the data transmission request expression of the first type, and
using the hash value to identify the replacement data transmission request expression as an entry in a lookup table corresponding to the data transmission request expression of the first type.

6. The method of claim 1, further comprising the steps of:
determining whether the retrieved data comprises an embedded data transmission request expression;
when the retrieved data comprises the embedded data transmission request expression, determining whether a replacement data transmission request expression exists as an entry in a lookup table corresponding to the data transmission request expression in the retrieved data;
when no replacement data transmission request expression exists in the lookup table, generating a replacement data transmission request expression;
storing the generated replacement data transmission request expression in the lookup table in association with the data transmission request expression in the retrieved data.

7. The method of claim 1, wherein the data transmission request expression is a first uniform resource locator (URL) having a first length and the replacement data transmission request expression is a second uniform resource locator (URL) having a second length.

8. The method of claim 1, wherein the data is a web page.

9. A method in a data processing system for replacing data transmission request expressions, the method comprising the steps of:
retrieving data with a data transmission request expression of a first type for sending to a requestor;
replacing the data transmission request expression in the retrieved data with a replacement data transmission request expression of a second type; and
sending the retrieved data with the replacement data transmission request expression to the requestor.

10. The method of claim 9, further comprising the steps of:
computing a hash value based on the data transmission request expression of the first type, and
using the hash value to identify the replacement data transmission request expression as an entry in a lookup table corresponding to the data transmission request expression of the first type.

11. The method of claim 9, further comprising the steps of:
determining whether a replacement data transmission request expression exists as an entry in a lookup table corresponding to the data transmission request expression in the retrieved data;
when no replacement data transmission request expression exists in the lookup table, generating a replacement data transmission request expression;
storing the generated replacement data transmission request expression in the lookup table in association with the data transmission request expression in the retrieved data.

12. The method of claim 9, wherein the data transmission request expression is a first uniform resource locator (URL) having a first length and the replacement data transmission request expression is a second uniform resource locator (URL) having a second length.

13. The method of claim 9, wherein the data is a web page.

14. A method in a data processing system having a web server with a web page, the method comprising the steps performed by the web server of:
receiving a first URL of a first type from a client, the first URL corresponding to the web page identified by a URL of a second type;
replacing the first URL with a replacement URL of the second type;
retrieving the web page using the replacement URL; and
sending the retrieved web page to the client.

15. A computer-readable medium containing instructions that cause a data processing system to perform a method for replacing data transmission request expressions, the method comprising the steps of:
receiving a data transmission request expression of a first type from a requestor, the data transmission request expression corresponding to data identified by a data transmission request expression of a second type;
replacing the data transmission request expression of the first type with a replacement data transmission request expression of the second type;
retrieving the data using the replacement data transmission request expression; and
sending the retrieved data to the requestor.

16. The computer-readable medium of claim 15, further comprising the steps of:
determining whether the retrieved data comprises a data transmission request expression of the second type; and
when the retrieved data comprises a data transmission request expression of the second type, replacing the data transmission request expression in the retrieved data with a replacement data transmission request expression of the first type.

17. The computer-readable medium of claim 15, further comprising the steps of:
determining whether the retrieved data comprises an embedded data transmission request expression;
when the retrieved data comprises a data transmission request expression, determining whether the data transmission request expression is supported by the requestor; and
when data transmission request expression in the retrieved data is not supported by the requestor, replacing the data transmission request expression in the retrieved data with a replacement data transmission request expression supported by the requestor.

18. The computer-readable medium of claim 15, further comprising the step of:
identifying the replacement data transmission request expression as an entry in a lookup table corresponding to the data transmission request expression of the first type.

19. The computer-readable medium of claim 15, further comprising the steps of:
computing a hash value based on the data transmission request expression of the first type, and
using the hash value to identify the replacement data transmission request expression as an entry in a lookup table corresponding to the data transmission request expression of the first type.

20. The computer-readable medium of claim 15, further comprising the steps of:
determining whether the retrieved data comprises an embedded data transmission request expression;
when the retrieved data comprises an embedded data transmission request expression, determining whether a replacement data transmission request expression exists as an entry in a lookup table corresponding to the data transmission request expression in the retrieved data;
when no replacement data transmission request expression exists in the lookup table, generating a replacement data transmission request expression;
storing the generated replacement data transmission request expression in the lookup table in association with the data transmission request expression in the retrieved data.

21. The computer-readable medium of claim 15, wherein the data transmission request expression is a first uniform resource locator (URL) having a first length and the replacement data transmission request expression is a second uniform resource locator (URL) having a second length.

22. The computer-readable medium of claim 15, wherein the data is a web page.

23. A computer-readable medium containing instructions that cause a data processing system to perform a method for replacing data transmission request expressions, the method comprising the steps of:
retrieving data with a data transmission request expression of a first type for sending to a requestor;
replacing the data transmission request expression in the retrieved data with a replacement data transmission request expression of a second type; and
sending the retrieved data with the replacement data transmission request expression to the requestor.

24. The computer-readable medium of claim 23, further comprising the steps of:
computing a hash value based on the data transmission request expression of the first type, and
using the hash value to identify the replacement data transmission request expression as an entry in a lookup table corresponding to the data transmission request expression of the first type.

25. The computer-readable medium of claim 23, further comprising the steps of:
determining whether a replacement data transmission request expression exists as an entry in a lookup table corresponding to the data transmission request expression in the retrieved data;
when no replacement data transmission request expression exists in the lookup table, generating a replacement data transmission request expression;
storing the generated replacement data transmission request expression in the lookup table in association with the data transmission request expression in the retrieved data.

26. The computer-readable medium of claim 23, wherein the data transmission request expression is a first uniform resource locator (URL) having a first length and the replacement data transmission request expression is a second uniform resource locator (URL) having a second length.

27. The computer-readable medium of claim 23, wherein the data is a web page.

28. A computer-readable medium containing instructions that cause a data processing system having a web server with a web page to perform a method for replacing URLs, the method comprising the steps of:
receiving a first URL of a first type from a client, the first URL corresponding to the web page identified by a URL of a second type;
replacing the first URL with a replacement URL of the second type;
retrieving the web page using the replacement URL; and
sending the retrieved web page to the client.

29. A data processing system comprising:
a secondary storage device having a stored data identified by a data transmission request expression of a first type;
a memory comprising a computer program that receives a data transmission request expression of a second type from a requestor, the data transmission request expression corresponding to data, replaces the data transmission request expression of the second type with a replacement data transmission request expression of the first type, retrieves the data using the replacement data transmission request expression, and sends the retrieved data to the requestor; and
a processing unit that runs the computer program.

30. The data processing system of claim 29, wherein the data transmission request expression is a first uniform resource locator (URL) having a first length and the replacement data transmission request expression is a second uniform resource locator (URL) having a second length.

31. The data processing system of claim 29, wherein the data is a web page.

32. A data processing system comprising:
a secondary storage device having a stored data having a data transmission request expression of a first type;
a memory comprising a computer program that retrieves the data for sending to a requestor, replaces the data transmission request expression in the retrieved data with a replacement data transmission request expression of a second type, and sends the retrieved data with the replacement data transmission request expression to the requestor; and
a processing unit that runs the computer program.

33. The data processing system of claim 32, wherein the data transmission request expression is a first uniform resource locator (URL) having a first length and the replacement data transmission request expression is a second uniform resource locator (URL) having a second length.

34. The data processing system of claim 32, wherein the data is a web page.

35. A data processing system for replacing data transmission request expressions, the data processing system comprising:
means for receiving a data transmission request expression of a first type from a requestor, the data transmission request expression corresponding to data identified by a data transmission request expression of a second type;
means for replacing the data transmission request expression of the first type with a replacement data transmission request expression of the second type;
means for retrieving the data using the replacement data transmission request expression; and
means for sending the retrieved data to the requestor.

36. A data processing system for replacing data transmission request expressions, the data processing system comprising:
means for retrieving data with a data transmission request expression of a first type for sending to a requestor;
means for replacing the data transmission request expression in the retrieved data with a replacement data transmission request expression of a second type; and
means for sending the retrieved data with the replacement data transmission request expression to the requestor.

37. A computer-readable memory device encoded with a data structure and a program that accesses the data structure, the program is by a processor in a system, the data structure having a plurality of entries, each entry comprising:
a data transmission request expression of a first type for retrieving a document identified by a data transmission request expression of a second type, wherein the program replaces the data transmission request expression of the first type with a data transmission request expression of a second type before retrieving the document.
